(19) United States
(12) Patent Application Publication
(10) Pub. No.: US 2012/0294018 A1
(43) Pub. Date: Nov. 22, 2012

(54) LED ILLUMINATION APPARATUS AND MANUFACTURING METHOD THEREOF

(75) Inventors: Cheol-Hyun Kim, Yangcheon-gu (KR); Sung-Chul Park, Gangdong-gu (KR)

(73) Assignee: V.L SYSTEM CO., LTD., Seoul (KR)

(21) Appl. No.: 13/522,129

(22) PCT Filed: Jan. 11, 2011
(86) PCT No.: PCT/KR2011/000151

§ 371 Date: Jul. 13, 2012

(30) Foreign Application Priority Data
Jan. 15, 2010 (KR) 10-2010-0003860

(51) Int. Cl. F21V 29/00; B23P 15/26

(52) U.S. Cl. 362/382; 29/726

(57) ABSTRACT

The present invention relates to an LED illumination apparatus and a manufacturing method thereof. The LED illumination apparatus according to one embodiment of the present invention comprises: a body in which a heat sink including a plurality of heat radiation fins is formed in a first area of a bottom surface portion thereof and in which a light source loading area is formed in a second area different from the first area in the bottom surface portion; a substrate loaded on the light source loading area of the body; and an LED light source module provided on the substrate. According to the present invention, since the heat sink is formed in the bottom surface portion of the body, the reduction of heat radiation efficiency in the LED illumination apparatus due to dust or excrement of birds and the like can be minimized. In addition, since the body is manufactured by extrusion molding, the manufacturing cost of the LED illumination apparatus can be remarkably reduced in comparison with prior die casting. In addition, since the length of the body can be adjusted arbitrarily, the present invention can be designed in various shapes according to a desired heat radiation area.

### TECHNICAL FIELD

The present invention relates to an LED (light emitting diode) illumination apparatus such as a streetlamp using an LED and a manufacturing method of the LED illumination apparatus, and more particularly, to an LED illumination apparatus where a heat sink that radiate a heat from an LED light source module is formed in a bottom surface portion of a body and is spaced apart from an LED light source portion along a longitudinal direction of the body.

### BACKGROUND ART

An LED is a device that converts an electric energy into a light energy by recombination of minor carriers injected into a semiconductor having a PN junction structure.

Recently, since the LED has a lower power consumption, a higher energy efficiency and a longer lifetime as compared with a related art fluorescent lamp and an incandescent lamp, utilization range of the LED has rapidly expanded around an indoor or outdoor illumination apparatus and an illumination apparatus for vehicle.

In an LED illumination apparatus, specifically, since a heat radiation efficiency is a direct dominant factor in determining lifetime and performance of a product, related companies have recently made an effort to improve the heat radiation efficiency.

A structure of an LED streetlamp as a representative LED illumination apparatus will be illustrated hereinafter.

As shown in FIG. 1, an LED streetlamp 10 is generally formed on an end portion of a horizontal bar 2 connected to an upper portion of a pillar 1. In addition, a rectifying circuit including an A/D converter and the like is formed in the pillar 1 or the LED streetlamp 10.

As shown in FIG. 2, the LED streetlamp 10 includes a body 20 connected to the horizontal bar 2, a plurality of LED light source modules 30 on a rear surface of the body 20 and a transparent cover 40 combined with a lower portion of the body 20 and covering the plurality of light source modules 30.

The body 20 includes an upper cover 21 having a hemispherical shape and a light source loading member 22 disposed under the upper cover 21. A heat sink 23 having a heat radiation fin shape for radiating a heat from the plurality of LED light source modules 30 is formed on a front surface of the upper cover 21, and a connecting member 24 connected to the horizontal bar 2 is formed on an end portion of the upper cover 21.

The body 20 is formed to have a single body through an aluminum die casting.

However, the related art LED streetlamp 10 has some problems as follows.

First, since the heat sink 23 is formed on the front surface of the body 20, dust, excrement of birds or carcass of insects and the like is accumulated on the heat sink 23 and heat radiation efficiency is rapidly reduced when used for a long time. Since a periodic cleaning is inevitable to prevent the above mentioned problems, cost for maintenance management greatly increases.

Second, since an area of the heat sink 23 is restricted by a size of the body 20, the related art structure has a basic limitation on improvement of heat radiation efficiency. In addition, when the body 20 is formed to have a large size for a sufficient heat radiation area, manufacturing cost of the LED streetlamp 10 excessively increases and the LED streetlamp 10 has excessive weight. Since manufacturing cost of the pillar 1 and the horizontal bar 2 supporting the LED streetlamp 10 increases as the weight of the LED streetlamp 10 increases, it is preferable to reduce the weight of the LED streetlamp 10.

Third, since the body 20 of the related art LED streetlamp 10 is mostly formed through an aluminum die casting, manufacturing cost is excessively high.

The above problems are not confined to the LED streetlamp 10 but are observed in most of LED illumination apparatuses such as a security lamp, an illumination lamp, an indoor lamp and the like.

### DISCLOSURE

### Technical Problem

The present invention has been made in an effort to solve the problems occurring in the related art, and an object of the present invention is to provide an LED illumination apparatus where reduction of heat radiation efficiency due to dust or excrement and the like is minimized. In addition, another object of the present invention is to provide an LED illumination apparatus where manufacturing cost is low and a weight is light. Further, another object of the present invention is to provide an LED illumination apparatus where a heat radiation area can be freely determined and various shapes can be designed.

### Technical Solution

In order to achieve the above object, an LED illumination apparatus includes: a body including a first region of a rear surface portion thereof where a heat sink having a plurality of heat radiation fins disposed is formed and a second region having a light source loading area; a plate in the light source loading area; and an LED light source module on the plate.

The LED illumination apparatus may further include: a plurality of heat pipe inserting holes in the body along a longitudinal direction, both end portions of each heat pipe inserting hole open through both side surfaces of the body, respectively; and a plurality of heat pipes inserted into the plurality of heat pipe inserting holes, respectively.

In addition, a penetration hole is formed in the plate and a heat radiation protrusion is formed in the light source loading area to be inserted into the penetration hole and directly contact the LED light source module.

In another aspect, a method of manufacturing an LED illumination apparatus includes: (a) forming a body including a heat pipe inserting hole along a longitudinal direction therein and a heat sink having a plurality of heat radiation fins along the longitudinal direction on a rear surface portion thereof through an extrusion molding; (b) forming a light source loading area by removing a part of the heat sink on the rear surface of the body; and (c) inserting a heat pipe into the heat pipe inserting hole, and forming a plate including an LED light source module in the light source loading area.

In the above method, the step (c) comprises: inserting the heat pipe into the heat pipe inserting hole through a shrinkage fitting method; and after cooling down the body, forming the plate including the LED light source module in the light source loading area.

### Advantageous Effects

According to the present invention, since a heat sink is formed on a rear surface of a body, reduction of heat radiation efficiency of an LED illumination apparatus due to dust or excrement of birds and the like is minimized.

In addition, since a body is formed though an extrusion molding, manufacturing cost of an LED illumination apparatus is remarkably reduced as compared with a related art die casting.

Further, since a length of a body is arbitrarily adjusted, an LED illumination apparatus can be designed to have various shapes according to a required heat radiation area.

### DESCRIPTION OF DRAWINGS

FIG. 1 is a perspective view showing an LED streetlamp according to the related art.

FIG. 2 is a cross-sectional view showing an LED streetlamp according to the related art.

FIGS. 3 and 4 are a perspective view of a rear surface and a perspective view, respectively, showing an LED streetlamp according to an embodiment of the present invention.

FIGS. 5 and 6 are a partial cross-sectional view and a cross-sectional view, respectively, showing an LED streetlamp according to an embodiment of the present invention.

FIG. 7 is an exploded perspective view showing an LED streetlamp according to an embodiment of the present invention.

FIG. 8 is a cross-sectional view showing an LED streetlamp according to another embodiment of the present invention.

FIG. 9 is a partial cross-sectional view showing an LED streetlamp according to another embodiment of the present invention.

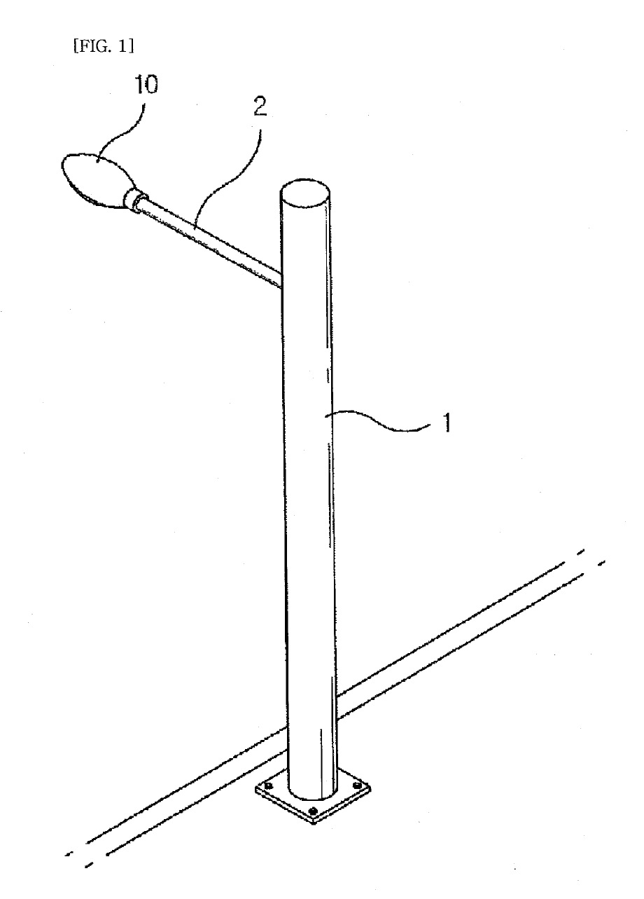

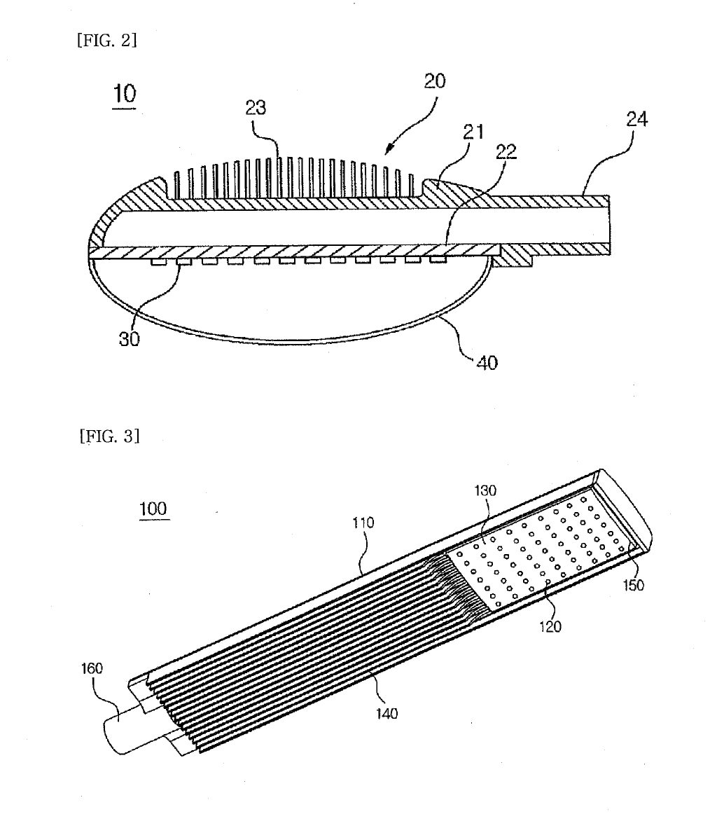

[Illustration about Reference Numbers]

| | |
|---|---|
| 100: LED streetlamp | 110: body |
| 112: cavity portion | 114: heat pipe inserting hole |
| 118: heat radiation protrusion | 120: LED light source module |
| 130: plate | 132: penetration hole |
| 140: heat sink | 150: transparent cover |
| 160: connecting member | 162: side surface stopper |
| 164: side surface stopper | 170: heat pipe |
| 180: fixing member | 182: cover groove |
| 184: connecting hole | 190: bolt |

### BEST MODE FOR INVENTION

Reference will now be made in detail to the preferred embodiments, examples of which are illustrated in the accompanying drawings.

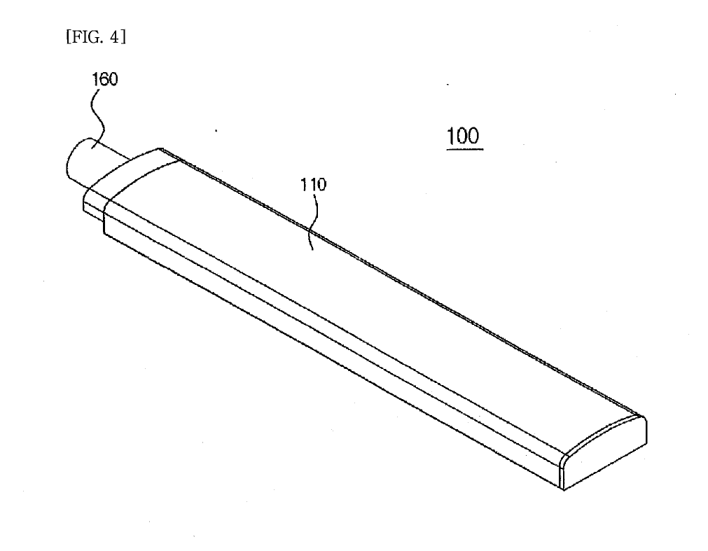

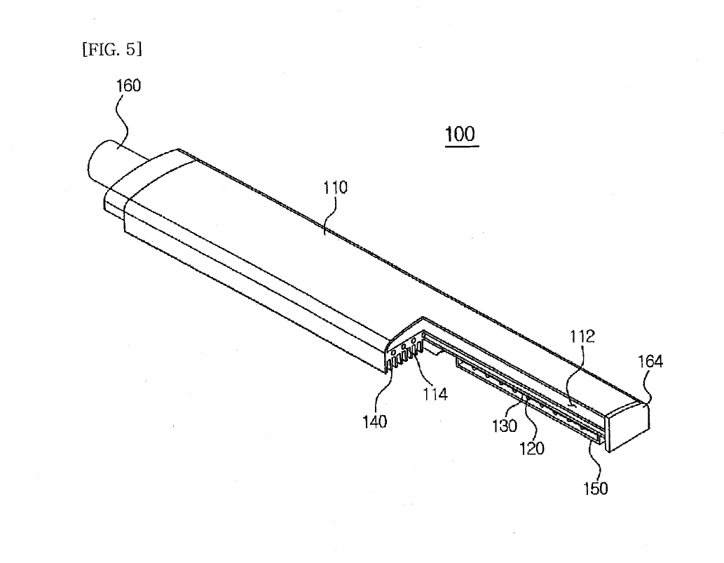

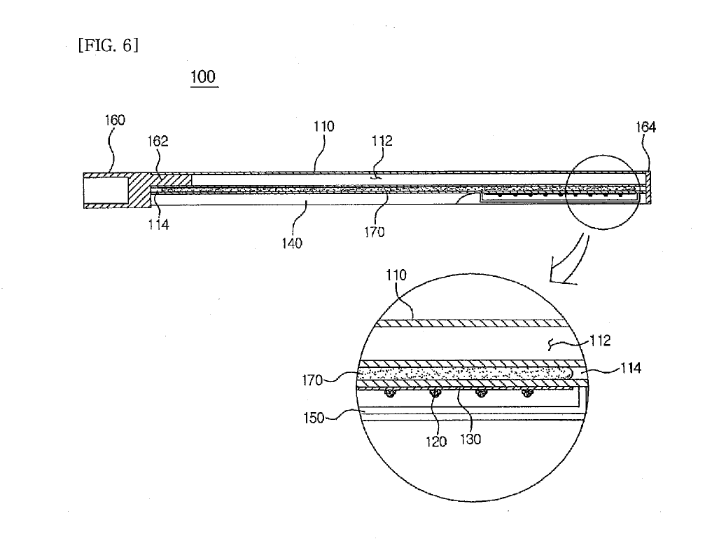

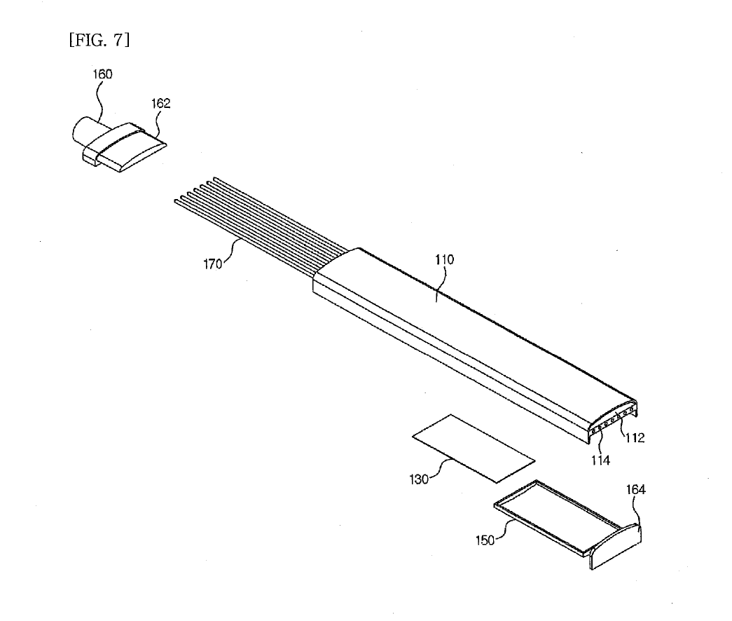

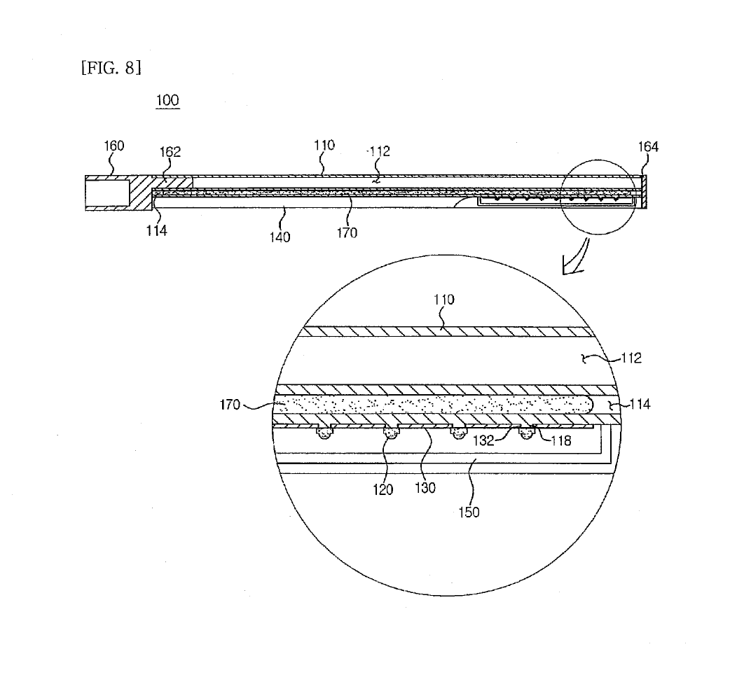

FIGS. 3 and 4 are a perspective view of a rear surface and a perspective view, respectively, showing an LED streetlamp 100 according to an embodiment of the present invention, FIGS. 5 and 6 are a partial cross-sectional view and a cross-sectional view, respectively, showing an LED streetlamp 100 according to an embodiment of the present invention, and FIG. 7 is an exploded perspective view showing an LED streetlamp 100 according to an embodiment of the present invention.

An LED streetlamp 100 according to an embodiment of the present invention includes a body 110 having a heat sink 140 of a heat radiation fin shape in a first region of a rear surface portion (a portion facing an illumination direction) thereof, an LED light source module 120 in a second region of the rear surface portion of the body 110 different from the first region and a plurality of heat pipes 170 transmitting a heat from the LED light source module 120 to the heat sink 140.

The body 110 may have a long rectangular shape in a plane view, and a front surface portion of the body 110 may be formed to have a curved surface or an inclined surface so that dust or excrement of birds can be easily rolled down.

A plurality of heat pipe inserting holes 114 are formed in the body 110 along a longitudinal direction of the body 110. The longitudinal direction may be defined by a direction along a long side of the body 110. When the body has a square shape in a plane view, the longitudinal direction may be defined by a direction along a line connecting a center of the first region where the heat sink 140 is formed and a center of the second region where the LED light source module 120 is formed.

In addition, a cavity portion 112 may be formed over the heat pipe inserting holes 114 along the longitudinal direction. Both end portions of the heat pipe inserting holes 114 and the cavity portion 112 may be open through both side surfaces of the body 110.

A heat pipe 170 is formed in the heat pipe inserting holes 114.

The cavity portion 112 in the body 110 does not only play a roll of reducing a weight of the body 110 but is also utilized as a space where circuit elements for driving the LED streetlamp 1000 are installed.

The heat sink 140 of a heat radiation fin shape is formed in the first region of the rear surface portion of the body 110, and a plate 130 where the plurality of LED light source modules 120 are installed is formed in the second region disposed continuously with the first region along the longitudinal direction of the body 110.

In addition, a transparent cover 150 for preventing contamination may be formed in a periphery of the LED light source modules 120.

A connecting member 160 for combining with a horizontal bar of a pillar is formed on an end portion of the body 110. The connecting member 160 also plays a role of blocking end portions of the heat pipe inserting holes 114 and the cavity portion 112. For example, a side surface stopper 162 may be formed to protrude from a side surface of the connecting member 160 and inserted into the cavity portion 112. In addition, an additional side surface stopper 164 blocking the other end portions of the heat pipe inserting holes 114 and the cavity portion 112 may be combined with the other end portion of the body 110.

When the body 110 is installed vertically with respect to the horizontal bar of the pillar, a connecting means may be formed on a side portion of the body 110. Even in this case, side surface stoppers 164 for blocking the heat pipe inserting holes 114 and the cavity portion 112 may be combined with both end portions of the body 110.

Although not shown, the LED light source modules 120 may include a package board having an electrode terminal, an LED chip on the package board and a lens cover over the LED chip. A fluorescent material (e.g. YAG) may be coated over the LED chip.

A method of manufacturing an LED streetlamp 100 according to an embodiment of the present invention will be illustrated hereinafter.

The body 110 having the above mentioned structure may be manufactured through an extrusion molding. In this case, there are advantages such that a size of the body 110 can be arbitrarily adjusted according to a desired heat radiation area and manufacturing cost is remarkably reduced as compared with a die casting.

In detail, the body 110 including the cavity portion 112 and the heat pipe inserting holes 114 along the longitudinal direction and the heat sink 140 corresponding to a whole length thereof is formed through an aluminum extrusion molding.

For an extrusion molding, each of a plurality of heat radiation fins constituting the heat sink 140 is formed along the longitudinal direction of the body 110.

Although a process for planarizing a part of the rear surface portion of the body 110 is added, manufacturing cost by the extrusion molding is reduced as compared with the die casting. In addition, since the whole body 110 is thin, a weight of the body 110 is greatly reduced as compared with the related art.

Next, a light source loading area is formed through a process of planarizing a region of the rear surface portion of the body 110 where the LED light source modules 120 are installed, thereby the body 110 completed. In this process, the heat radiation fins of the heat sink 140 disposed in the light source loading area are removed.

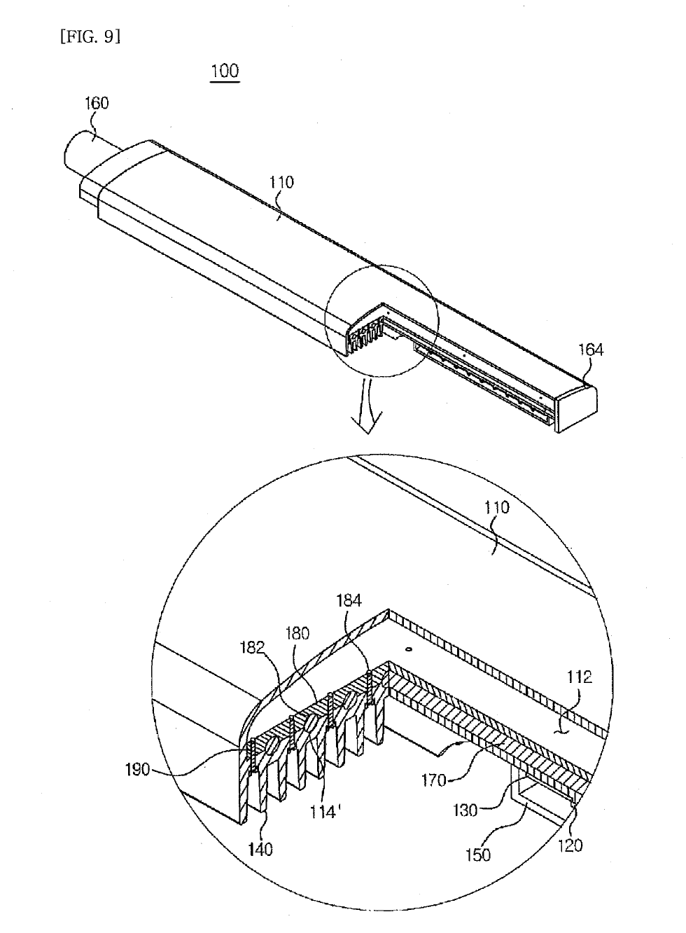

Since the body 110 contacts the plate 120 in the light source loading area, the light source loading area may be formed to have a flat surface. As shown in FIG. 8, however, the light source loading area may be formed such that a plurality of heat radiation protrusions 118 protrude from a flat surface. The above structure will be illustrated later.

Before or after the light source loading area is formed, a plurality of incision grooves may be formed on the heat radiation fins constituting the heat sink 140 along a direction perpendicular to the longitudinal direction of the body 110 to enlarge a heat radiation area.

After the body 110 is formed and before the LED light source modules 120 are installed, the heat pipes 170 may be inserted into the heat pipe inserting holes 114. For the purpose of maximally contacting an outer surface of the heat pipes 170 and an inner surface of the heat pipe inserting holes 114, the heat pipes 170 may be combined through a shrinkage fitting method.

For example, after a diameter of the heat pipe inserting holes is expanded by heating the body 110 in an oven and the like with a predetermined temperature, the heat pipes 170 may be inserted into the heat pipe inserting holes 114 and may be cooled down. As a result, the heat pipes 170 and the body 110 can tightly contact each other.

After the heat pipes 170 are installed, the plate 130 having the LED light source modules 120 is formed in the light source loading area of the rear surface portion of the body 110 and circuit elements required for connection with external power source are formed.

Next, the connecting member 160 and the side surface stopper 164 are combined with both end portions of the body 110 and the transparent cover 150 is formed in the periphery of the LED light source modules 120.

FIG. 8 is a cross-sectional view showing an LED streetlamp 100 according to another embodiment of the present invention. A plurality of penetration holes 132 are formed in a plate 130 and a plurality of heat radiation protrusions 118 are formed in a light source loading area of a body 110. The heat radiation protrusions 118 are inserted into the penetration holes 132 of the plate 130 to directly contact a plurality of LED light source modules 120 of the plate.

The heat radiation protrusions 118 may be formed to have a single body with the body 110 while the light source loading area is formed. Alternatively, the heat radiation protrusions 118 may be combined with the body 110 as an additional element of assembly type.

According to the previous embodiment (referring to FIG. 6), the heat generated in the LED light source modules 120 is transmitted to the body 110 through the plate 130 and then is radiated to the heat sink 140 through the heat pipes 170.

In this embodiment (FIG. 8), however, since the heat generated in the LED light source modules 120 is transmitted directly to the heat radiation protrusions 118 having a single body with the body 110 without through the plate 130, heat radiation efficiency is greatly improved.

Accordingly, when this heat radiation structure is adopted, a plastic PCB plate instead of the plate 130 of aluminum may be used. For example, the plastic PCB plate may be formed of an insulating material such as epoxy resin, phenol resin, Teflon resin, silicon resin, polyester resin, polyimide resin and the like.

The plastic PCB plate has an advantage of lower cost as compared with a metallic plate. In addition, when the plastic PCB plate is used, the LED light source modules 120 and driving circuit elements are installed on the same plate. As a result, manufacturing process is simplified.

Although the penetration holes 132 and the heat radiation protrusions 118 in the light source loading area have the same number as the LED light source modules 120, the penetration hole 132 in the plate 130 may be formed to have a slit shape where a plurality of LED light source modules are formed and the heat radiation protrusion 118 may be formed to have a long rectangular pillar shape which is inserted into the penetration hole 132 of a slit shape to directly contact boards of plurality of LED light source modules 120.

Instead of forming the penetration holes 132 directly in the plate 130, first and second plates may be formed to be spaced apart from each other and a gap space between the first and second plates may be utilized as a penetration hole of a slit shape.

In the previous structure, the heat sink 140 and the LED light source modules 120 are disposed on the rear surface portion of the body 120 continuously along the longitudinal direction, and the LED light source modules 120 are formed in a single area.

Alternatively, the heat sink 140 and the LED light source modules 120 may be alternately disposed along the longitudinal direction. For example, the light source loading area may be formed at a center portion of the rear surface portion of the body 110 and the LED light source modules 120 may be formed in the light source loading area. In this case, the heat sinks 140 may be formed at both side portions of the LED light source modules 120.

In addition, the LED light source modules 120 may be formed at both side portions of the rear surface portion of the body 110 and the heat sink 140 may be formed at a center portion of the rear surface portion of the body 110. An alternating number of the heat sinks 140 and the LED light source modules 120 may be adjusted as necessary.

Further, since the heat sink 140 is not required to be formed at a single side portion of the LED light source module 120, the heat sinks 140 may be formed at a periphery of at least two sides of the light source loading area where the LED light source modules 120 are installed.

In the previous structure, the body 110 is formed to have a single body and the heat pipes 170 are inserted into the heat pipe inserting holes 114 along the longitudinal direction in the body 110 through a shrinkage fitting method and the like.

Instead of forming the heat pipe inserting holes 114 in the body 110, as shown in FIG. 9, an additional fixing member 180 may be combined with the body 110 to fix the heat pipes 170.

For example, insertion grooves 114′ each having a semicircle shape in a cross-sectional view may be formed on a bottom surface of the cavity portion 112 of the body 110 along the longitudinal direction, and the heat pipes 170 may be inserted into the insertion grooves 114′. Next, a fixing member 180 including cover grooves 182 corresponding to the insertion grooves 114′ may be combined with the heat sink 140. In this case, the heat pipe inserting holes 114 (of FIG. 5) is substituted with spaces between the inserting grooves 114′ and the cover grooves 182.

The fixing member 180 may have a plate shape that closely contacts the body 110. The shape of the fixing member 180 is not limited to the plate shape.

For assembly, connecting holes 184 may be formed in the fixing member 180, and bolts 190 may be inserted into the connecting holes 184 from the rear surface portion of the body 110 between the plurality of heat radiation fins constituting the heat sink 140.

Even in this case, the body 110 having the insertion grooves 114′ on the bottom surface of the cavity portion 112 along the longitudinal direction may be manufactured through an extrusion molding, and the fixing member 180 having the cover grooves 182 along the longitudinal direction may be manufactured through an extrusion molding.

Although this structure of assembly may have a lower heat conductivity and a process for forming the connecting holes 184 or tightening the bolts 190 may be added as compared with the structure by a shrinkage fitting method, this structure of assembly may be utilized as an alternative in a circumstance where a shrinkage fitting method can not be used.

When the cavity portion 112 is not formed in the body 110, the insertion grooves 114′ may be formed on a front surface of the body 110 along the longitudinal direction, and the heat pipes 170 may be inserted into the insertion grooves 114′. Next, the fixing member 180 may be combined to the front surface of the body 110.

The above mentioned structure of the LED streetlamp 110 may be applied to an LED illumination apparatus having different purposes such as an illumination lamp and a security lamp. In addition, the above mentioned structure of the LED streetlamp 110 may be applied to a traffic light and an indoor LED illumination lamp installed in an interior place where a lot of dust is generated.

Although embodiments of the present invention are illustrated, the present invention is not limited to the embodiments described herein, and various modifications and variations can be made in the present invention. In addition, it will be apparent that the present invention covers the modifications and variations of this invention provided they come within the scope of the appended claims and their equivalents.

1. An LED illumination apparatus, comprising:
a body including a first region of a rear surface portion thereof where a heat sink having a plurality of heat radiation fins disposed along a longitudinal direction is formed and a second region disposed continuously with the first region along the longitudinal direction;
a heat pipe inserting hole in the body along the longitudinal direction, both end portions of the heat pipe inserting hole open through both side surfaces of the body, respectively;
a heat pipe for transmitting a heat absorbed from the second region to the first region, the heat pipe inserted into the heat pipe inserting hole and a whole outer surface of the heat pipe contacting the body;
a plate formed in the second region of the body; and
an LED light source module formed on the plate.

2. The LED illumination apparatus according to claim 1, wherein a front surface portion of the body has one of a curved surface and an inclined surface for rolling down dust or excrement of birds.

3. The LED illumination apparatus according to claim 1, further comprising:
an insertion groove on a front surface portion of the body along the longitudinal direction or on a bottom surface portion of a cavity portion in the body along the longitudinal direction;
a fixing member combining with the front surface portion of the body or the bottom surface portion of the cavity portion, the fixing member including a cover groove corresponding to the insertion groove and along the longitudinal direction, the insertion groove and the cover groove constituting the heat pipe inserting hole; and
a connecting member fixing the fixing member to the body.

4. The LED illumination apparatus according to claim 1, wherein a penetration hole is formed in the plate and a heat radiation protrusion is formed in the second region to be inserted into the penetration hole and directly contact the LED light source module.

5. A method of manufacturing an LED illumination apparatus, comprising:
(a) forming a body including a heat pipe inserting hole along a longitudinal direction therein and a heat sink having a plurality of heat radiation fins along the longitudinal direction on a rear surface portion thereof through an extrusion molding;
(b) forming a light source loading area by removing a part of the heat sink on the rear surface of the body; and
(c) inserting a heat pipe into the heat pipe inserting hole for transmitting a heat generated in the light source loading area to the heat sink such that a whole outer surface of the heat pipe contacts the body, and forming a plate including an LED light source module in the light source loading area.

6. The method according to claim 5, wherein the step (c) comprises:
inserting the heat pipe into the heat pipe inserting hole through a shrinkage fitting method; and
after cooling down the body, forming the plate including the LED light source module in the light source loading area.
